(19) United States
(12) Patent Application Publication
(10) Pub. No.: US 2012/0069169 A1
(43) Pub. Date: Mar. 22, 2012

(54) INFORMATION PROCESSING APPARATUS, METHOD, AND STORAGE MEDIUM

(75) Inventor: Tatsuya Dejima, Tokyo (JP)

(73) Assignee: CASIO COMPUTER CO., LTD., Tokyo (JP)

(21) Appl. No.: 13/212,378

(22) Filed: Aug. 18, 2011

(30) Foreign Application Priority Data
Aug. 31, 2010 (JP) 2010-193637

(51) Int. Cl. H04N 7/18

(52) U.S. Cl. 348/77; 348/E07.085

(57) ABSTRACT

An image capturing unit 12 captures an image of a finger 31 of a user performing a press operation within a virtual input device area associated with a predetermined input device, the virtual input device being formed on a top surface of a desk or the like, and outputs data of the captured image data. A sound input unit 13 inputs a sound generated from the virtual input device area on which a press operation is performed by a user's finger and outputs data of the sound. A touch operation detection unit 51 detects a press operation by the user's finger on the virtual input device area based on the captured image data outputted from the image capturing unit 12 and the sound data outputted from the sound input unit 13. An input processing unit 53 inputs predetermined information based on the detection result of the touch operation detection unit 51.

This application is based upon and claims the benefit of priority from the prior Japanese Patent Application No. 2010-193637, filed Aug. 31, 2010, the entire contents of which are incorporated herein by reference.

### BACKGROUND OF THE INVENTION

1. Field of the Invention

The present invention relates to an information processing apparatus, method, and program that receive a user operation which inputs information by way of the user's hand action without using any input device, and more particularly to a technique capable of both reliably detecting a user operation without any false detection in a simple configuration and setting up an easier operation as the user operation.

2. Related Art

Conventionally, a technique has been researched and developed that inputs predetermined information by way of detecting a predetermined human hand action without using an input device such as a keyboard or a piano keyboard.

For example, Japanese Patent Application Publication No. 1994-28096 discloses a technique of inputting a character by spatially detecting a hand action. Also, Japanese Patent Application Publication No. 1994-118962 discloses a technique that controls a sound source by way of a sensor attached to a hand. Furthermore, Japanese Patent Application Publication No. utterance such as “this” and “that” at the time of inputting information by way of spatially detecting a hand action.

Recently, there is a desire to input information by way of pressing a surface of a desk or the like using the surface of the desk or the like to simulate a keyboard. In order to realize such a desire, there are two requirements to be met. Firstly, it is necessary to reliably detect a user operation without any false detection in a simple configuration. Secondly it is necessary to provide, as a user operation, an easier operation for a user. However, with conventional techniques including the techniques disclosed in Japanese Patent Application Publication No. 1994-28096, Japanese Patent Application Publication No. 1994-118962, and Japanese Patent Application Publication No. 1993-19957, it is difficult to realize both of these. In order to reliably detect a user operation without any false detection, it is necessary to detect the actual contact of a user's finger with a surface of a desk or the like. Hereinafter, such detection is referred to as “finger touch detection”. In order to realize the finger touch detection by applying the technique disclosed in Japanese Patent Application Publication No. 1994-28096, it is not sufficient to only capture an image of the top of a user's hand from above. It is also necessary to capture an image of a space between the user's palm and a surface of a desk or the like from the side. For this purpose, at least two image capturing apparatuses are required, and image processing has to be executed on both of the images respectively captured by the image capturing apparatuses. As a result, the system configuration becomes complicated and large. Accordingly, it is impossible to meet the requirement of a simple configuration.

On the other hand, in order to simplify the configuration, if an image of the user's hand is taken only from above, it becomes impossible to determine whether the finger has simply stopped (away from the surface of the desk or the like) or the finger has pressed the desk or the like (has touched the surface thereof). As a result, it is impossible to realize the finger touch detection. Accordingly, it is very difficult to reliably detect a user operation with no false detection. In a case in which the technique disclosed in Japanese Patent Application Publication No. 1994-118962 is applied, it is necessary to attach sensors to a hand. As a result, the configuration becomes complicated and large. Accordingly, it is impossible to meet the requirement of a simple configuration. In a case in which the technique disclosed in Japanese Patent Application Publication No. 1993-19957 is applied, each time when a user presses and thus operates with his or her finger a surface of a desk or the like that is used to simulate a keyboard, the user is required to utter the name or the like of a key corresponding to the area thus pressed and operated. For example, for the purpose of word processing, if a user utters the name of a key corresponding to a pressed and operated area each time the user presses and operates with his or her finger the surface area of a desk or the like that is used to simulate a keyboard, it is just reading text aloud for word processing, which is very laborious and tiresome for the user.

Also, for example, for the purpose of playing an electric piano, if a user utters the name of a key corresponding to a pressed and operated area each time the user presses and operates with his or her finger the surface area of a desk or the like that is used to simulate a piano keyboard, it is just reading aloud or singing music to be played by the electric piano, which is very laborious and tiresome for the user. In the first place, in an environment where the user cannot make utterances, it is impossible to apply the technique disclosed in Japanese Patent Application Publication No. 1993-19957. Therefore, even if the technique disclosed in Japanese Patent Application Publication No. 1993-19957 is applied, it is impossible to meet the requirement of providing, as a user operation, an easier operation for a user.

### SUMMARY OF THE INVENTION

The present invention is conceived in view of the above circumstances and it is an object of the present invention to realize both requirements of reliably detecting a user operation without any false detection even in a simple configuration, and of providing, as a user operation, an easier operation for the user.

In accordance with one aspect of the present invention, there is provided an information processing apparatus that regards a predetermined surface as a virtual input device area, and inputs predetermined information when a user performs a touch operation of causing a finger to touch the virtual input device area, the information processing apparatus, comprising: an image capturing unit that captures an image of the surface where the virtual input device area is formed, and outputs data of the captured image; an identification information detection unit that detects identification information indicative of a state of touch of the finger of the user with the virtual input device area; a touch operation detection unit that detects the touch operation on a predetermined area of the virtual input device area, based on the data of the captured image outputted from the image capturing unit, and the identification information detected by the identification information detection unit; and an information input unit that inputs the predetermined information based on a detection result of the touch operation detection unit.

In accordance with another aspect of the present invention, there is provided an information processing method of an information processing apparatus that regards a predetermined surface as a virtual input device area, and inputs predetermined information when a user performs a touch operation of causing a finger to touch the virtual input device area, the information processing apparatus being provided with an image capturing unit that captures an image of the surface where the virtual input device area is formed and outputs data of the captured image, the information processing method comprising the steps of: an identification information detection step of detecting identification information capable of identifying whether or not the finger of the user has touched the virtual input device area; a touch operation detection step of detecting the touch operation on a predetermined area of the virtual input device area, based on the data of the captured image outputted by the image capturing unit, and the identification information detected in the identification information detection step; and an information input step of inputting the predetermined information based on a detection result of the touch operation detection step.

In accordance with another aspect of the present invention, there is provided a storage medium readable by a computer used in an information processing that regards a predetermined surface as a virtual input device area, and inputs predetermined information when a user performs a touch operation of causing a finger to touch the virtual input device area, and that has an image capturing unit that captures an image of the surface where the virtual input device area is formed and outputs data of the captured image, the storage medium having stored therein a program executable by the computer to function as: an identification information detection unit that detects identification information indicative of a state of contact of the finger of the user with the virtual input device area; a touch operation detection unit that detects the touch operation on a predetermined area of the virtual input device area, based on the data of the captured image outputted from the image capturing unit, and the identification information detected by the identification information detection unit; and an information input unit that inputs the predetermined information based on a detection result of the touch operation detection unit.

According to the present invention, when a user operation of inputting information with a user's hand action is performed without using an input device, it is possible both to reliably detect a user operation with no false detection in a simple configuration and to provide an easier operation as user operation.

### BRIEF DESCRIPTION OF THE DRAWINGS

FIG. 1 is a front elevation view showing an external configuration of an information processing apparatus according to one embodiment of the present invention;

FIG. 2 is a cross-sectional view taken along a line A-A′ of FIG. 1 showing one example of a configuration of a side of the information processing apparatus shown in FIG. 1;

FIG. 3 is a diagram illustrating a user operation in a case in which a virtual input device area is associated with a computer keyboard in virtual input device processing carried out by the information processing apparatus shown in FIG. 1;

FIG. 4 is a functional block diagram showing a functional configuration of the information processing apparatus shown in FIG. 1 to carry out the virtual input device processing;

FIG. 5 is a diagram showing one example of a captured image used in the virtual input device processing corresponding to the user operation shown in FIG. 3 from among the virtual input device processing carried out by the information processing apparatus shown in FIG. 1;

FIG. 6 is a diagram illustrating a method of detecting a finger position used in the virtual input device processing corresponding to the user operation shown in FIG. 3 from among the virtual input device processing carried out by the information processing apparatus shown in FIG. 1;

FIG. 7 is a diagram showing a state of the captured image shown in FIG. 5 partitioned in accordance with specification information;

FIG. 8 is a diagram showing an input operation resultant image displayed as a screen on a display unit that has been acquired as a result of the virtual input device processing carried out by the information processing apparatus shown in FIG. 1 corresponding to the user operation shown in FIG. 3;

FIG. 9 is a diagram illustrating a user operation in a case in which the virtual input device area is associated with a piano keyboard in the virtual input device processing carried out by the information processing apparatus shown in FIG. 1;

FIG. 10 is a diagram showing one example of a captured image used in the virtual input device processing corresponding to the user operation shown in FIG. 9 from among the virtual input device processing carried out by the information processing apparatus shown in FIG. 1;

FIG. 11 is a flowchart showing one example of flow of the virtual input device processing carried out by the information processing apparatus shown in FIG. 1;

FIG. 12 is a flowchart illustrating one example of a detailed flow of positioning processing from among the virtual input device processing shown in FIG. 11;

FIG. 13 is a flowchart showing one example of a detailed flow of ON detection processing from among the virtual input device processing shown in FIG. 11;

FIG. 14 is a flowchart showing one example of a detailed flow of ON detection processing from among the virtual input device processing shown in FIG. 11, which is different from the example of FIG. 12; and

FIG. 15 is a block diagram showing a hardware configuration to implement the information processing apparatus shown in FIG. 1.

### DETAILED DESCRIPTION OF THE INVENTION

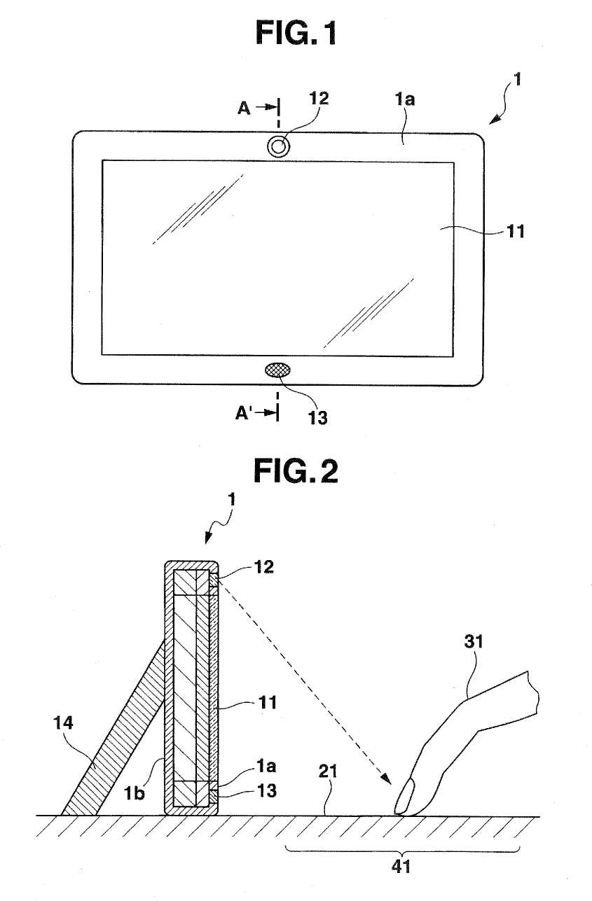

The following describes an embodiment of the present invention with reference to the drawings. FIG. 1 is a front elevation view showing an example of an external configuration of an information processing apparatus 1 according to one embodiment of the present invention. As shown in FIG. 1, the information processing apparatus 1 is configured as a digital photo frame. Therefore, in the front surface 1a of the information processing apparatus 1, there are provided a display unit 11 configured by a liquid crystal display or the like, for example, an image capturing unit 12 configured by a digital camera or the like, for example, and a sound input unit 13 configured by a microphone or the like. Hereinafter, from among directions parallel to the line A-A′ of FIG. 1, a bottom up direction (from A′ to A) is referred to as “upward direction”, and a top down direction (from A to A′) is referred to as “downward direction”. Here, the image capturing unit 12 is provided towards the top of the center area of the display unit 11, and the sound input unit 13 is provided towards the bottom of the center area of the display unit 11.

FIG. 2 is a cross-sectional view taken along a line A-A′ of FIG. 1 showing one example of a side configuration of the information processing apparatus 1. As shown in FIG. 2, the information processing apparatus 1 can be disposed, for example, on the top surface of a desk 21 supported by a back stand 14 attached to a back surface lb thereof. In this case, a user can use a predetermined area 41 in front of the front surface 1a of the information processing apparatus 1 on the top surface of the desk 21 to simulate a predetermined input device, perform exactly the same operation as with the predetermined input device, and thereby input desired information into the information processing apparatus 1. Hereinafter, a predetermined area (the predetermined area 41, in the example of FIG. 2) in front of the front surface 1a of the information processing apparatus 1 on a surface where the information processing apparatus 1 is disposed such as the top surface of the desk 21, i.e., an area that is used to simulate a predetermined input device is referred to as “virtual input device area”.

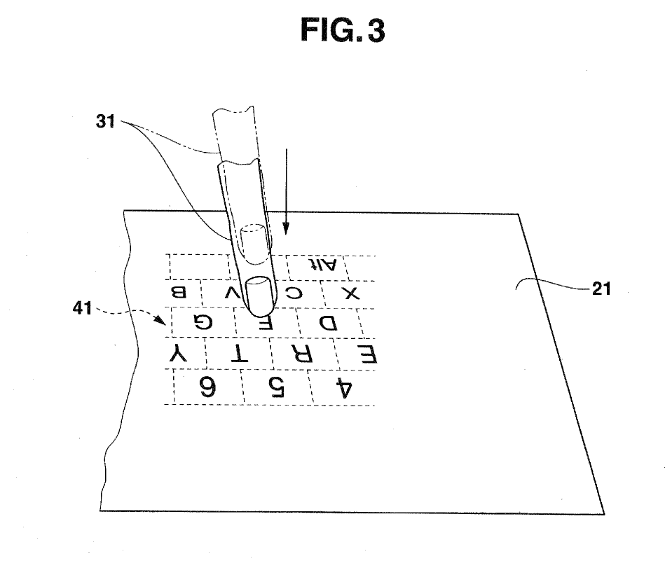

FIG. 3 is a diagram illustrating a user operation in a case in which the virtual input device area 41 on the top surface of the desk 21 is associated with a computer keyboard. In FIG. 3, the computer keyboard layout drawn by dotted lines on the virtual input device area 41 is shown for ease of explanation. That is, the virtual input device area 41 is only an area of a surface of a real object (the top surface of the desk 21, in the example of FIG. 3). Therefore, a computer keyboard layout is not always presented on the surface of the real object where the virtual input device area 41 is formed. This means that the user is supposed to perform here what is called touch typing. For users who are not skilled in touch typing, however, a sheet, a setting board, or the like on which a computer keyboard layout is printed may be laid on the virtual input device area 41 (the top surface of the desk 21 or the like). As shown in FIG. 3, when a user desires to input information assigned to an “F” key of a computer keyboard into the information processing apparatus 1, the user may perform a tapping operation by a finger 31, i.e., a press operation, at a position corresponding to the “F” key in the virtual input device area 41.

The information processing apparatus 1 detects such a press operation by the finger 31, inputs information corresponding to the press operation such as information assigned to the “F” key of a computer keyboard, in the example of FIG. 3, and carries out various kinds of processing based on the input information. Hereinafter, such a series of processes of the information processing apparatus 1 is referred to as “virtual input device processing”. Although in the example of FIG. 3 the user operation detected by the virtual input device processing is a press operation by the finger 31, the operation is not limited to this. For example, any operation (hereinafter, referred to as a “touch operation”) that is performed by contact of the finger 31 or a nail with the surface of the real object, such as a scratching operation by a nail on the top surface of the desk 21 or the like, can be detected by the virtual input device processing. This means that, to put it more generally, the virtual input device processing refers to a series of processes in which the information processing apparatus 1 detects a touch operation, inputs information corresponding to the touch operation, and carries out various kinds of processing based on the input information. However, for ease of description, the example of FIG. 3 will be used in the following description of the virtual input device processing.

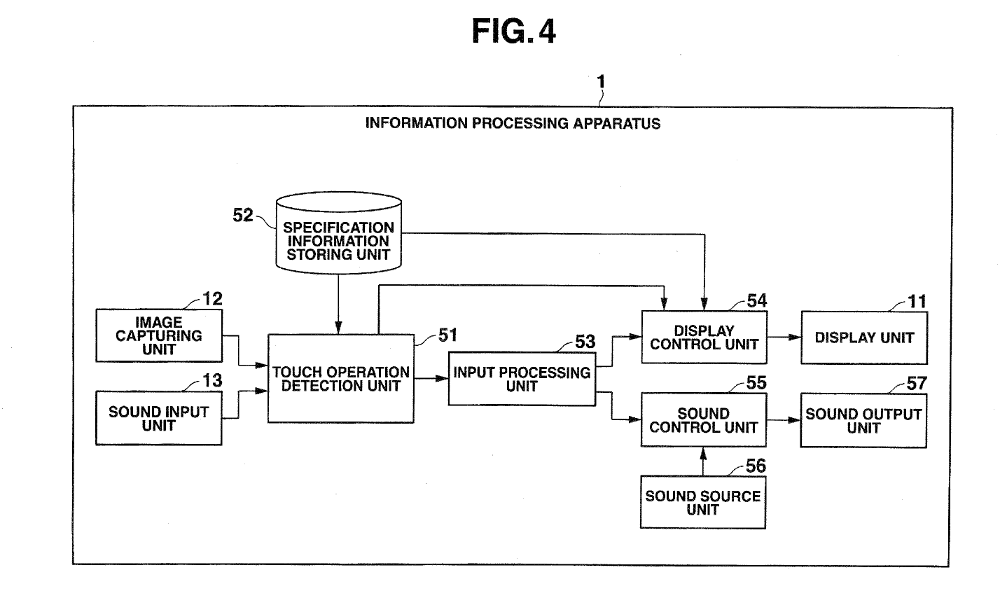

FIG. 4 is a functional block diagram showing a functional configuration of the information processing apparatus 1 for carrying out the virtual input device processing.

In addition to the display unit 11, the image capturing unit 12, and the sound input unit 13, which have been described above, the information processing apparatus 1 is provided with a touch operation detection unit 51, a specification information storing unit 52, an input processing unit 53, a display control unit 54, a sound control unit 55, a sound source unit 56, and a sound output unit 57.

The image capturing unit 12 captures an image from obliquely above the top surface of the desk 21 where the virtual input device area 41 is formed as shown in FIG. 2 described above and provides data of the acquired image (hereinafter, referred to as “captured image”) to the touch operation detection unit 51.

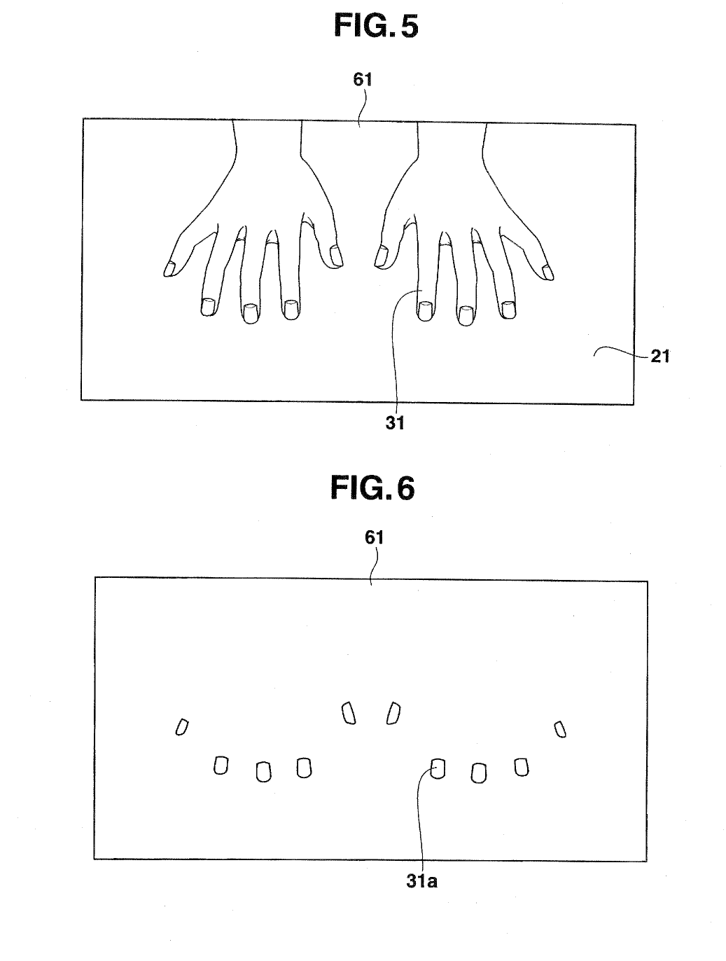

FIG. 5 shows one example of the captured image 61. The captured image 61 of the example of FIG. 5 shows the top of the user's right and left hands (including a finger 31) disposed above the desk 21.

The touch operation detection unit 51 shown in FIG. 4 detects positions of the user's respective fingers in the captured image based on the captured image data. Though the method of detecting the position of a finger is not limited, in the present embodiment, a method shown in FIG. 6 is assumed to be employed. FIG. 6 is a diagram illustrating the method of detecting the position of a finger. As shown in FIG. 6, the touch operation detection unit 51 detects an area 31a (hereinafter, referred to as “nail area 31a”) of a nail of each finger 31 from the captured image 61 and detects the position of each nail area 31a in the captured image 61 as the position of each finger 31.

The specification information storing unit 52 shown in FIG. 4 stores specification information. Here, the specification information refers to information specifying in advance the position of the image of the virtual input device area 41 with respect to the view field range of the image capturing unit 12. The view field range of the image capturing unit 12 refers to the overall area range of effective pixels of the image capturing device of the image capturing unit 12, i.e., the range of the captured image. This means that the specification information is information specifying the position of the image of the virtual input device area 41 within the captured image. For example, in the example of FIG. 3, i.e., in a case in which the virtual input device area 41 is associated with a computer keyboard, the specification information is information specifying which constituent key of the computer keyboard corresponds to which area within the view field range of the image capturing unit 12 (the range of the captured image).

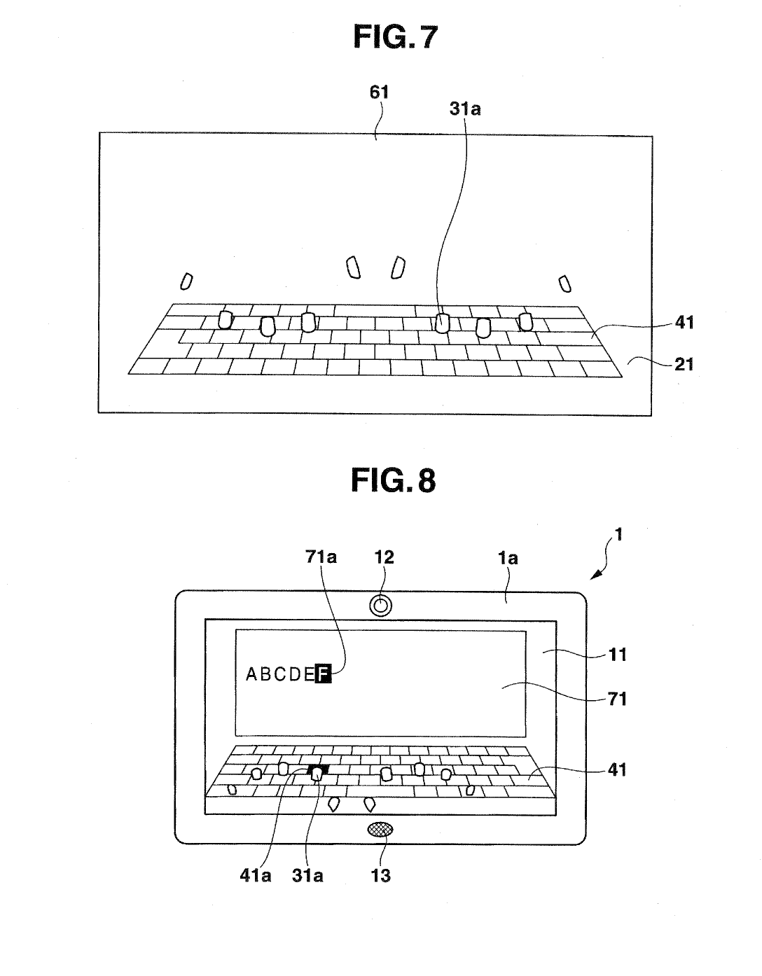

Based on such specification information and the detected position of each finger 31, the touch operation detection unit 51 identifies a relative position of the finger 31 in the virtual input device area 41. FIG. 7 shows a state of the captured image 61 partitioned in accordance with the specification information. As shown in FIG. 7, the area of the captured image 61 partitioned in accordance with the specification information corresponds to the virtual input device area 41. That is, the image of a computer keyboard that would have been captured by the captured image 61 if the computer keyboard were disposed on the top surface of the desk 21 is virtually represented by the specification information. The image area corresponding to the computer keyboard is defined as corresponding to the virtual input device area 41. More specifically, areas partitioned in perspective within the view field range of the image capturing unit 12 (the range of the captured image 61 in the example of FIG. 7) correspond to the computer keyboard layout, and accordingly, correspond to respective constituent keys of the computer keyboard. A set of areas (hereinafter, referred to as “key areas”) corresponding to predetermined keys is thus defined as corresponding to the virtual input device area 41. This means that, in a case in which the virtual input device area 41 is associated with a computer keyboard such as FIG. 3, information that specifies positions of respective key areas within the view field range of the image capturing unit 12 is employed as the specification information. In the example of FIG. 7, within the range of the captured image 61, the touch operation detection unit 51 identifies a relative position of the finger 31 in the virtual input device area 41, by associating the position of the detected nail area 31a with the position corresponding to the virtual input device area 41 defined by the specification information.

Incidentally, the captured image 61 shown in FIGS. 5 to 7 is not presented to the user but used only for internal processing of the touch operation detection unit 51.

The touch operation detection unit 51 shown in FIG. 4 executes the series of processes, i.e., the processes described above until the relative position of the finger 31 is identified in the virtual input device area 41, based on the data of the captured image 61 at a predetermined time interval. Then, the touch operation detection unit 51 computes track and speed of the finger 31 in the virtual input device area 41 based on the execution result at the predetermined time interval. Here, the speed includes a value “0”, which indicates that the finger 31 has stopped. Therefore, when the finger 31 suddenly stops moving, the touch operation detection unit 51 recognizes the key area corresponding to the position where the finger 31 stops as the target of press operation from among the constituent key areas of the virtual input device area 41. For example, in FIG. 7, it is assumed that a nail area numbered with 31a stops suddenly from moving at a position shown in FIG. 7. In such a case, the touch operation detection unit 51 identifies that the nail area 31a is disposed at a key area corresponding to the “F” key in the virtual input device area 41 and thereby recognizes the key area corresponding to the “F” key is the target of a press operation. Hereinafter, the key area that is recognized as the target of the press operation is referred to as “target key area”.

The touch operation detection unit 51 utilizes data of a sound generated when the finger 31 taps the top surface of the desk 21 or the like (at the time of the press operation) for determination of whether or not the target key area is pressed by the finger 31. That is, as shown in FIG. 2, the sound input unit 13 inputs on a steady basis the sound in the vicinity of the virtual input device area 41 on the top surface of the desk 21 and provides data of the sound to the touch operation detection unit 51. Here, the sound data provided to the touch operation detection unit 51 is represented in the time domain. The touch operation detection unit 51 transforms the sound data provided from the sound input unit 13 from the time domain representation to the frequency domain representation by executing FFT (Fast Fourier Transform) processing thereon. The touch operation detection unit 51 determines whether or not a level of a primary vibration exceeds a threshold value based on the sound data in the frequency domain and thereby determines whether or not a press operation is performed by the finger 31. In a case in which the level of the primary vibration exceeds the threshold value, the touch operation detection unit 51 determines that the finger 31 has tapped the top surface of the desk 21 or the like (press operation is performed). For example, it is assumed that the primary vibration when the finger 31 taps the top surface of the desk 21 or the like (performs a press operation) is a sound of the 20 Hz band and the threshold value is −10 dB. In such a case, the touch operation detection unit 51 refers to 20 Hz band data from among the sound data represented in the frequency domain and, if the level of the data exceeds −10 dB, determines that the finger 31 has performed a press operation. It should be noted that the values presented above are only examples and that the frequency band on which the threshold determination is performed is not limited to a single band, but a plurality of frequency bands may be used as targets of the threshold determination to prevent a false detection, which will be described later.

In summary of the above, the touch operation detection unit 51 recognizes the target key area in the virtual input device area 41 based on the captured image data outputted from the image capturing unit 12 and detects the press operation on the target key area based on the sound data outputted from the sound input unit 13. Hereinafter, such detection by the touch operation detection unit 51 is referred to as “detection of press operation on the target key area”.

The detection result of the press operation on the target key area is supplied from the touch operation detection unit 51 to the input processing unit 53. After that, the input processing unit 53 inputs information assigned to the key corresponding to the target key area and executes various kinds of processing according to the input information. That is, the input processing unit 53 is provided with an input function of inputting information and a processing execution function of executing processing according to the input information. What is called a “word processor” function is included in the processing execution function. While the input processing unit 53 is implementing such a word processor function, it is assumed that a user pressed a key area corresponding to the “F” key in the virtual input device area 41 on the desk 21. Incidentally, there is no presentation of “F” key on the top surface of the desk 21, as described above. In this case, the touch operation detection unit 51 executes the series of processes described above, thereby detects press operation on the target key area, and supplies the detection result that the key area corresponding to the “F” key is pressed to the input processing unit 53. Then the input processing unit 53 implements the input function and, according to the supplied detection result, inputs information assigned to the “F” key such as character information “F”. Furthermore, the input processing unit 53 implements the word processor function and thereby executes processing of adding a character “F”, for example, into the sentence in the process of creation.

Also, the input processing unit 53 provides information related to the target key area to the display control unit 54. The information related to the target key area includes not only information that identifies a key corresponding to the target key area but also any information that is assigned to the key (i.e., information that is inputted) and the like. The display control unit 54 performs control of causing the display unit 11 to display an image including information related to the target key area thus supplied, i.e., an image (hereinafter, referred to as “input operation resultant image”) showing the operation result of the user on the virtual input device area 41.

FIG. 8 is a diagram showing the input operation resultant image displayed as a screen on the display unit 11. Here, the “screen” refers to an image displayed on the entire display area of a display device or a display unit (the display unit 11, in the present embodiment) provided in a display device. In the example of FIG. 8, the input operation resultant image includes an input information display area 71, an image of the virtual input device area 41, and the nail area 31a as a screen of the display unit 11. In the input information display area 71, the input information in accordance with the press operation on the target key area is displayed including the past input history. That is, in a case in which the input processing unit 53 is implementing the word processor function, a sentence or the like created by a user is displayed in the input information display area 71. In the example of FIG. 8, information “ABCDE” that has been input in the past is displayed, and on the extreme right thereof, “F”, i.e., the information 71a that is newly input is highlighted. The image of the virtual input device area 41 is displayed based on the specification information stored in the specification information storing unit 52. In the example of FIG. 8, the key area 41a in the virtual input device area 41 is highlighted. This highlighting indicates that this is the newest target key area. This means that in the example of FIG. 8 the highlighted key area 41a is the newest target key area, and as a result of the press operation on the key area 41a, “F”, the information 71a is highlighted in the input information display area 71. The nail area 31a is displayed based on the detection result by the touch operation detection unit 51 shown in FIG. 4.

It should be noted that the presentation form of the newest key area 41a and the newest information 71a inputted by the press operation on the key area 41a is not limited to highlighting, and any presentation form may be applicable as long as newly input information is distinguishable from the past input information. Furthermore, it is not required to display the images of the virtual input device area 41 and the nail area 31a as long as the newest target key area 41a can be presented. However, for a user who is performing a press operation on the empty desk 21 (having no presentation of any keyboard layout or the like), there might be a case in which it is difficult to instantaneously recognize which key is currently pressed without presentation of the images of the virtual input device area 41 and the nail area 31a. For this reason, it is preferable to display the images of the virtual input device area 41 and the nail area 31a to avoid such a case, i.e., so as to enable the user to easily and instantaneously recognize which key is currently pressed and being operated on.

Referring back to FIG. 4, the input processing unit 53 further provides information related to the target key area to the sound control unit 55. Based on the information related to the target key area, the sound control unit 55 performs control of causing the sound output unit 57 to output a sound generated by the sound source unit 56. For example, in a case in which the virtual input device area 41 is associated with a computer keyboard such as an example shown in FIG. 3, the sound source unit 56 stores data of a sound generated when a key on the computer keyboard is actually pressed, i.e., a click-clack sound. In such a case, the sound control unit 55 acquires the sound data, converts it to an analog sound signal, and provides it to the sound output unit 57. The sound output unit 57 is configured by a speaker or the like, for example, and outputs the sound corresponding to the analog sound signal provided from the sound control unit 55, i.e., the click-clack sound generated from the pressed keyboard. With this, the user can feel as if he or she is actually operating the computer keyboard.

In the above, a description has been given of the functional configuration of the information processing apparatus 1 using an example in which the virtual input device area 41 is associated with a computer keyboard. However, a computer keyboard is only an example. For example, by changing the specification information, the information processing apparatus 1 having the functional configuration in question can employ a virtual input device area 41 associated with a piano keyboard and thereby carry out the “virtual input device processing”. This means that if the user performs a setting operation so that the virtual input device area 41 is associated with a computer keyboard, it becomes possible to operate using the virtual input device area 41 to simulate a computer keyboard, as described with reference to FIG. 3. On the other hand, if the user performs a setting operation so that the virtual input device area 41 is associated with a piano keyboard, it becomes possible to operate using the virtual input device area 41 to simulate a piano keyboard.

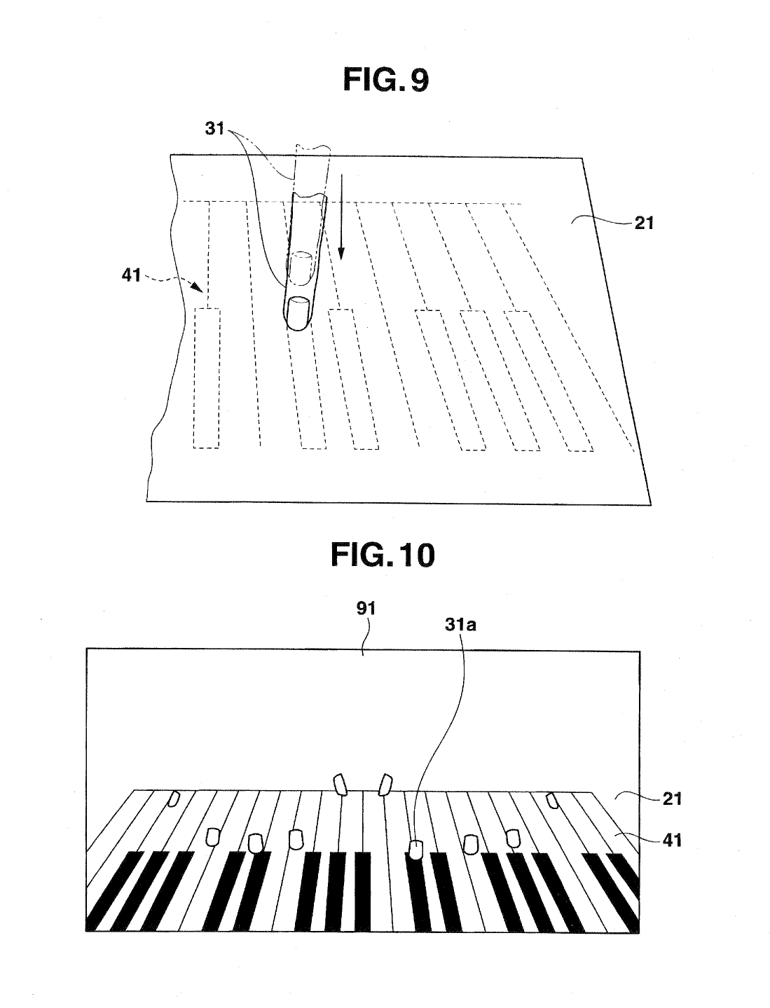

FIG. 9 is a diagram illustrating a user operation in a case in which the virtual input device area 41 on the top surface of the desk 21 is associated with a piano keyboard. In FIG. 9, the keyboard layout shown by dotted lines on the virtual input device area 41 is drawn only for ease of explanation. That is, the virtual input device area 41 is only an area of a surface of an object (the top surface of the desk 21, in the example of FIG. 9). Therefore, it is not usual for a keyboard layout to be shown on the surface of the real object where the virtual input device area 41 is formed. This means that the user is supposed to be able to play the piano without looking at the keyboard. For users who are not skilled in such an operation, however, a sheet, a setting board, or the like on which a keyboard layout is printed may be laid on the virtual input device area 41 (the top surface of the desk 21 or the like). As shown in FIG. 9, when a user desires to generate a sound at a desired pitch (frequency) from the information processing apparatus 1, the user may perform an operation of tapping by the finger 31, i.e., a press operation on a key area corresponding to the key to which the desired pitch is assigned in the virtual input device area 41.

In this case, the specification information storing unit 52 shown in FIG. 4 of the information processing apparatus 1 stores information that specifies which constituent key of the piano keyboard corresponds to which area within the view field range of the image capturing unit 12 (the range of the captured image) as specification information.

Based on such specification information and the detected position of each finger 31, the touch operation detection unit 51 identifies a relative position of the finger 31 in the virtual input device area 41. FIG. 10 shows a state of the captured image 91 partitioned in accordance with the specification information. As shown in FIG. 10, the area partitioned in accordance with the specification information in the captured image 91 corresponds to the virtual input device area 41. That is, the image of a piano keyboard that would have been captured by the captured image 91 if the piano keyboard were disposed on the top surface of the desk 21 is virtually represented by the specification information. The image area corresponding to the piano keyboard is defined as corresponding to the virtual input device area 41. More specifically, areas partitioned in perspective within the view field range of the image capturing unit 12 (the range of the captured image 91 in the example of FIG. 10) correspond to the piano keyboard layout, and accordingly, correspond to respective constituent keys of the piano keyboard. For consistency with the description in the case of the computer keyboard, each area corresponding to a predetermined key is similarly referred to as a “key area”. Thus, exactly the same as in the case of the computer keyboard, a set of key areas is defined as corresponding to the virtual input device area 41. In the example of FIG. 10, within the range of the captured image 91, the touch operation detection unit 51 identifies a relative position of the finger 31 in the virtual input device area 41 by associating the position of the detected nail area 31a with the position corresponding to the virtual input device area 41 defined by the specification information. After that, the touch operation detection unit 51 executes exactly the same processing as the case of the virtual input device area 41 associated with the computer keyboard and thereby detects a press operation on the target key area.

The detection result of the press operation on the target key area is supplied from the touch operation detection unit 51 shown in FIG. 4 to the input processing unit 53. Here, the input processing unit 53 implements the input function and what is called a sequencer function as a processing execution function. That is, the input processing unit 53 implements the input function and, according to the supplied detection result, inputs information (hereinafter, referred to as “pitch information”) that can identify the pitch assigned to the key corresponding to the target key area. For example, pitch information such as “C3” is inputted to the input processing unit 53. The input processing unit 53 implements the sequencer function and controls the sound control unit 55, which will be described later, to cause the sound output unit 57 to output the sound at the pitch (frequency) identified by pitch information such as “C3”. This means that the sound control unit 55 performs control of causing the sound source 56 to generate a sound at a pitch that is identified by the pitch information and the sound output unit 57 to output the sound. For example, it is assumed that the sound source 56 is configured by what is called a PCM (Pulse Code Modulation) sound source. In this case, the sound control unit 55 causes the sound source unit 56 to play back data of a sound at the pitch identified by the pitch information, converts the sound data to an analog sound signal, and provides it to the sound output unit 57. The sound output unit 57 is configured by a speaker or the like, for example, and outputs a sound corresponding to the analog sound signal provided from the sound control unit 55, i.e., sound at a predetermined pitch generated from a PCM sound source (the sound source unit 56). With this, it becomes possible to cause the information processing apparatus 1 that is not equipped with a piano keyboard to function as an electric piano. That is, even if no piano keyboard is available, the user can play exactly as if playing an electric piano by using the virtual input device area 41 formed on a surface of any real object such as the top surface of the desk 21, instead of a piano keyboard.

Incidentally, in this case as well, the display control unit 54 performs control to cause the display unit 11 to display an input operation resultant image including the target key area and the information inputted by the input processing unit 53. More specifically, for example, the display unit 11 displays an input operation resultant image (not shown) including the image of the virtual input device area 41, which is associated with a piano keyboard, and the nail area 31a and showing the newest target key area (the key area corresponding to the last pressed key) so as to be distinguishable from other key areas.

In the above, a description has been given of a functional configuration of the information processing apparatus 1. It should be noted that the functional configuration shown in FIG. 4, which has been described above, is only an example and the information processing apparatus 1 may assume any kind of functional configuration as long as the virtual input device processing can be carried out.

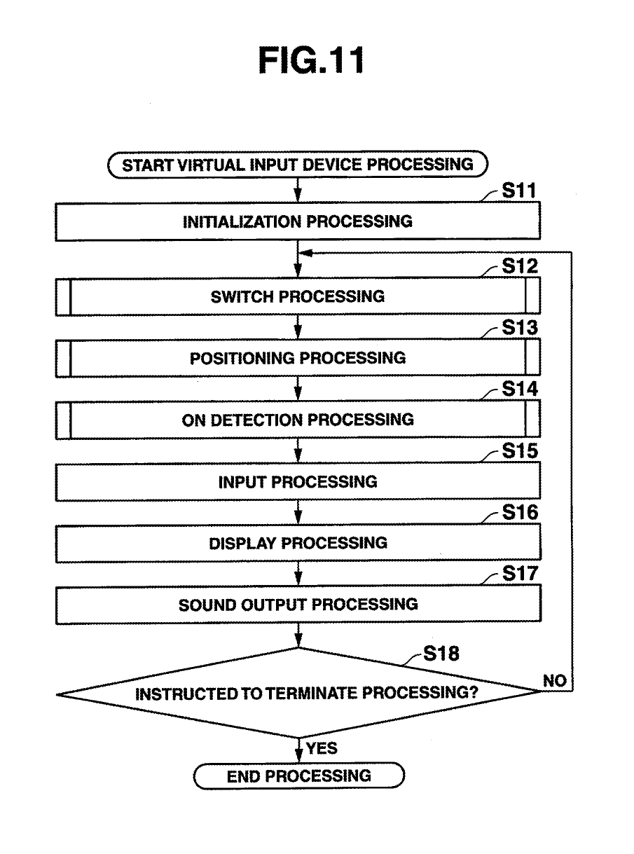

In the following, a description will be given of flow of the virtual input device processing carried out by the information processing apparatus 1 having the functional configuration shown in FIG. 4 with reference to FIGS. 11 to 14.

FIG. 11 is a flowchart showing one example of a main flow of the virtual input device processing. The virtual input device processing starts with a predetermined operation by a user after the information processing apparatus 1 is powered-on, for example.

In step S11, each constituent element of the information processing apparatus 1 executes initialization processing.

In step S12, each constituent element of the information processing apparatus 1 executes switch processing. The switch processing refers to processing of selecting and setting predetermined options such as operation modes and setting conditions including a case of initial settings. For example, in the present embodiment, the user can select either one of the computer and piano keyboards as the input device to be associated with the virtual input device area 41. If the computer keyboard is selected, the user can perform the operation described above with reference to FIG. 3, i.e., exactly the same operation as the press operation on a computer keyboard using the virtual input device area 41 to simulate a computer keyboard. On the other hand, if the piano keyboard is selected, the user can perform the operation described above with reference to FIG. 9, i.e., exactly the same operation as the press operation on a piano keyboard using the virtual input device area 41 to simulate a piano keyboard. As one type of switch processing here, the touch operation detection unit 51 or the like receives the selection operation of the user and carries out the setting of associating either one of the computer and piano keyboards with the virtual input device area 41 according to the selection of the user. As another type of switch processing, the touch operation detection unit 51 and the like may carry out the setting of the kind of the surface of the real object (such as wood in the case of the top surface of the desk 21) where the virtual input device area 41 is formed, the kind of tone to be audibly outputted in a case in which the piano keyboard is selected, and the like.

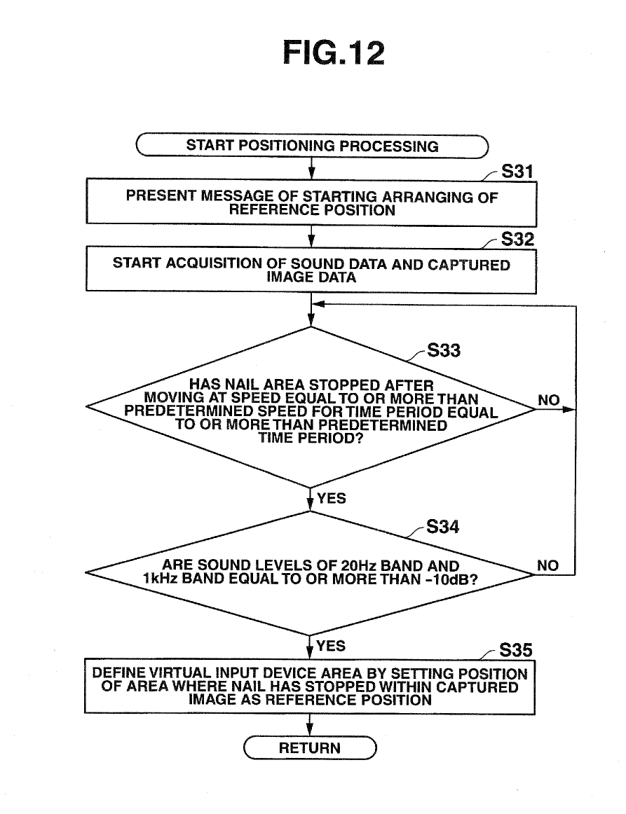

In step S13, the touch operation detection unit 51 executes positioning processing. The positioning processing refers to processing of setting a predetermined position on the surface of a real object (the top surface of the desk 21 in the example described above) on which the user performs the press operation as a position of a predetermined key area (reference position) in the virtual input device area 41. This means that there is a predetermined key area to be set as an initial position (reference position) where the user has to firstly place his or her finger 31. For example, in the case of the computer keyboard, the key area position corresponding to a “J” key is the initial position. On the other hand, in the case of the piano keyboard, the key area position corresponding to the key at the pitch of “C3” is the initial position. The positioning processing is calibration processing which determines such an initial position on a surface (the top surface of the desk 21 in the example described above) where the virtual input device area 41 is formed. A more specific description of the positioning processing of the present embodiment will be given later with reference to the flowchart of FIG. 12. After the positioning processing ends, a partial area of the surface of the real object where the user performs a press operation is set to be the virtual input device area 41.

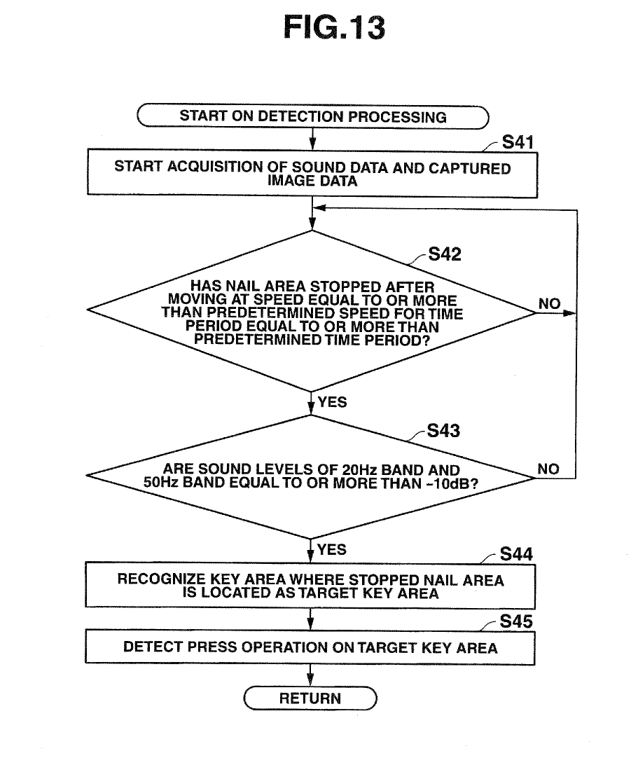

In step S14, the touch operation detection unit 51 executes ON detection processing. In the present embodiment, the ON detection processing refers to processing of detecting the touch operation on the target key area, e.g., press operation on the target key area, in a case in which the virtual input device area 41 is associated with computer keyboard or piano keyboard. A detailed description of the ON detection processing of the present embodiment will be described later with reference to the flowchart of FIG. 13.

After the detection result of press operation on the target key area is supplied from the touch operation detection unit 51 to the input processing unit 53 shown in FIG. 4, control proceeds from step S14 to step S15. In step S15, the input processing unit 53 executes input processing. The input processing refers to processing in which the input processing unit 53 implements the input function and the processing execution function described above. As a part of the input processing, the input processing unit 53 implements the input function of inputting information assigned to the key corresponding to the target key area and implements the processing execution function of executing various kinds of processing according to the input information. For example, in a case in which the virtual input device area 41 is set to be associated with a computer keyboard in the switch processing of step S12, the word processor function is implemented as the processing execution function. Here, the target key area corresponds to a key pressed by the user from among the constituent keys of the keyboard. Therefore, in this case, the input processing unit 53 inputs character information such as an “F” assigned to the key corresponding to the target key area and executes processing of adding a character such as the “F” to the sentence in the process of creation, for example. On the other hand, for example, in a case in which the virtual input device area 41 is set to be associated with a piano keyboard in the switch processing of step S12, the sequencer function is implemented as the processing execution function. Here, the target key area corresponds to the key pressed by the user from among the constituent keys of the piano keyboard. Therefore, in this case, the input processing unit 53 inputs pitch information such as “C3” corresponding to the target key area. After that, the input processing unit 53 controls the sound control unit 55 to cause the sound output unit 57 to output a sound at the pitch (frequency) that is identified by the pitch information such as “C3”. Such processing of sound output is executed as the sound output processing of step S17, which will be described later.

In step S16, the display control unit 54 executes display processing. The display processing refers to processing of causing the display unit 11 to display the input operation resultant image including information related to the target key area. For example, in a case in which the virtual input device area 41 is set to be associated with a computer keyboard in the switch processing of step S12, the input operation resultant image shown in FIG. 8 is displayed on the display unit 11 by the display processing. That is, the target key area (the key area 41a corresponding to the “F” key in the example of FIG. 8) and the information assigned to the key corresponding to the target key area, i.e., the information (the character “F” in the example of FIG. 8) inputted in the process of step S15 are displayed on the display unit 11. On the other hand, for example, in a case in which the virtual input device area 41 is set to be associated with a piano keyboard in the switch processing of step S12, though not illustrated, the target key area (the key area corresponding to the pressed key such as “C3”) and information assigned to the key corresponding to the target key area, i.e., the information (pitch information such as “C3”) inputted in the process of step S15 are displayed on the display unit 11 by the display processing.

In step S17, the sound control unit 55 executes sound output processing. The sound output processing refers to processing of causing the sound output unit 57 to output a sound based on information related to the target key area. For example, in a case in which the virtual input device area 41 is set to be associated with a computer keyboard in the switch processing of step S12, data of a recorded click-clack sound is provided from the sound source unit 56 to the sound control unit 55, and the click-clack sound is outputted from the sound output unit 57 based on the sound data by the sound output processing. On the other hand, for example, in a case in which the virtual input device area 41 is set to be associated with a piano keyboard in the switch processing of step S12, a sound at a pitch (frequency) identified by the pitch information inputted in the process of step S15 such as the sound of “C3” is outputted from the sound output unit 57 by the sound output processing.

In step S18, each constituent element of the information processing apparatus 1 determines whether or not it is instructed to terminate the processing. The instruction of terminating the processing is not limited, and various kinds of instructions such as a power off instruction of the information processing apparatus 1 can be employed as the instruction of terminating the processing. If there has not yet been an instruction to terminate the processing, a determination of NO is made in step S18, control goes back to step S12, and the processes thereafter are repeated. On the other hand, if there has been an instruction to terminate the processing, a determination of YES is made in step S18, and the entire virtual input device processing ends.

In the following, a description will be given of a detailed flow of the positioning processing of step S13 among such virtual input device processing. FIG. 12 is a flowchart illustrating a detailed flow of the positioning processing. When the switch processing of step S12 ends, the positioning processing of step S13 starts, as described above, and a series of following processes of steps S31 to S35 are executed.

In step S31, the touch operation detection unit 51 presents a message indicating the start of positioning with the reference position. The method of presentation of the message is not limited and a method can be employed such that the sound output unit 57 outputs a sound message, for example. In the present embodiment, however, a method is employed in which an image including a text message such as “Tap your finger and nail strongly at the position to be set as the reference position. The ‘J’ key ('C3′ key) will be set there.” is displayed on the display unit 11. This means that, in the present embodiment, the touch operation detection unit 51 controls the display control unit 54 to cause the display unit 11 to display an image including such a text message.

In step S32, the touch operation detection unit 51 starts acquisition of data of a sound from the sound input unit 13 and data of a captured image from the image capturing unit 12.

In step S33, the touch operation detection unit 51 determines whether or not the nail area 31a has stopped after moving at a speed equal to or more than a predetermined speed for a time period equal to or more than a predetermined time period within the range of the captured image based on the captured image data acquired from the image capturing unit 12. Here, the predetermined speed and the predetermined time period are not limited, and any value can be employed. It should be noted that, however, the purpose of the determination process of step S33 is to determine whether or not the user, who determined a reference position on the top surface of the desk 21 or the like to be used to simulate a keyboard to perform press operation, has stopped (in the direction parallel to the surface) his or her finger 31 at the reference position. That is, to determine whether or not the user intends to fix the reference position is the purpose of the determination process of step S33. Therefore, it is preferable that appropriate values in view of such a purpose be employed as the predetermined speed and the predetermined time period. From such a viewpoint, in the present embodiment a speed sufficient to determine that the finger 31 has not yet stopped is employed as the predetermined speed, and “20 msec” is employed as the predetermined time period.

In a case in which the nail area 31a is moving within the range of the captured image and has not yet stopped, or, even if the nail area 31a is stopped, in a case in which the moving speed thereof immediately before stopping is less than the predetermined speed or the moving time period thereof immediately before stopping is less than the predetermined time period, it is determined that the user has no intention yet to determine the reference position. Accordingly, in such a case, a determination of NO is made in step S33, and control goes back to step S33. This means that, until the nail area 31a stops after moving at a speed equal to or more than the predetermined speed for a time period equal to or more than the predetermined time period, the determination process of step S33 is repeated. After that, when it is determined that the nail area 31a has stopped after moving at a speed equal to or more than the predetermined speed for a time period equal to or more than the predetermined time period, it is determined that the user intends to fix the stop position as the reference position, a determination of YES is made in step S33, and control proceeds to step S34.

In step S34, based on the sound data (data in the frequency domain after processed by FFT) acquired from the sound input unit 13, the touch operation detection unit 51 determines whether or not 20 Hz band and 1 kHz band levels of the sound are equal to or more than −10 dB.

Here, the reason why the process of step S34 is executed after YES is determined in step S33 will be explained. The determination to be YES in step S33 means that the user intends to fix the reference position. However, the determination in step S33 alone is not sufficient to determine that the user intends to fix the reference position. For example, there can be a case in which the user has temporarily stopped his or her finger 31 at a position, but the user may move his or her finger 31 again without tapping the position with his or her finger 31 and the nail thereof. In such a case, if a determination is made that the user intends to fix the position as the reference position based on the determination in step S33 alone, this would be a false determination. For the purpose of avoiding such a false determination, i.e., for the purpose of determining more reliably (accurately) that the user intends to fix the reference position, the process of step S34 is provided.

More specifically, in the present embodiment, the text message “Tap your finger and nail strongly at the position to be set as the reference position.” is displayed on the display unit 11 in the process of step S31. Therefore, the user, who has recognized the message, will strongly tap the finger 31 and the nail thereof at the position desired to be set as the reference position and thereby indicate the intention to determine that position as the reference position. This means that the touch operation detection unit 51 cannot make a final determination that the user intends to fix the reference position even if a determination of YES is made in step S33. A simple confirmation that his or her finger 31 has stopped above a position is not sufficient to make the final determination. It is only after detection of tapping (press operation) with his or her finger 31 and the nail thereof at a position to be set as the reference position that the touch operation detection unit 51 can finally determine that the user intends to fix the reference position. The process of step S34 is determination processing to make such a final determination.

More specifically, the 20 Hz band is a frequency band of a sound generated from the desk 21 at the time of tapping (press operation) on the desk 21 with the finger 31. Therefore, the touch operation detection unit 51 can detect the tapping (press operation) of the user on the desk 21 with the finger 31 when the sound level of the 20 Hz band is equal to or more than −10 dB. On the other hand, the 1 kHz band is a frequency band of a sound generated from the desk 21 at the time of tapping (press operation) on the desk 21 with a nail. Therefore, the touch operation detection unit 51 can detect the tapping (press operation) of the user on the desk 21 with a nail when the sound level of the 1 kHz band is equal to or more than −10 dB. It should be noted that values such as 20 Hz, 1 kHz, and −10 dB that are employed in the determination process of step S34 are only examples on the premise that the virtual input device area 41 is formed on the top surface of the desk 21. This means that, according to properties such as material and size of the surface of the real object on which the virtual input device area 41 is formed, preferable values to be employed in the determination process of step S34 vary.

In the present embodiment, if the sound level of either one of the 20 Hz band and the 1 kHz band is lower than −10 dB, it is determined that the user has no intention yet to fix the reference position. In such a case, a determination of NO is made in step S34, control goes back to step S33, and the processes thereafter are repeated. This means that until the nail area 31a stops after moving at a speed equal to or more than the predetermined speed for a time period equal to or more than the predetermined time period and, further, the sound levels of both the 20 Hz band and the 1 kHz band become equal to or more than −10 dB, a determination is made that the user has no intention yet to fix the reference position, a determination of NO is made in the processes of steps S33 and/or S34, and the positioning processing enters a waiting state. After that, when the nail area 31a stops after moving at a speed equal to or more than the predetermined speed for a time period equal to or more than the predetermined time period and, further, sound levels of both the 20 Hz band and the 1 kHz band become equal to or more than −10 dB, it is finally determined that the user intends to fix the reference position. In such a case, a determination of YES is made in the both processes of steps S33 and S34, and control proceeds to step S35.

In step S35, the touch operation detection unit 51 defines the virtual input device area 41 by setting the position of the stopped nail area 31a within the captured image as the reference position.

With this, the positioning processing ends. As a result, the process of step S13 of FIG. 11 ends, and control proceeds to the ON detection processing of step S14.

In the following, a description will be given of a detailed flow of the ON detection processing of step S14. FIG. 13 is a flowchart showing a detailed flow of the ON detection processing.

In step S41, the touch operation detection unit 51 starts acquisition of data of a sound from the sound input unit 13 and data of a captured image from the image capturing unit 12.

In step S42, based on the captured image data acquired from the image capturing unit 12, the touch operation detection unit 51 determines whether or not the nail area 31a has stopped after moving at a speed equal to or more than a predetermined speed for a time period equal to or more than a predetermined time period within the range of the captured image. Here, the predetermined speed and the predetermined time period are not limited, and any values can be employed, which are obviously independent of the respective values employed in step S33 of FIG. 12. It should be noted that, however, the purpose of the determination process of step S42 is to determine whether or not the user, who determined a target key area in the virtual input device area 41 to be used to simulate a computer keyboard or a piano keyboard to perform press operation, has stopped (in the direction parallel to the top surface of the desk 21 or the like) his or her finger 31 at a position of the target key area. This means that, determining whether or not the user intends to fix the target key area to be pressed is the purpose of the determination process of step S42. Therefore, it is preferable that appropriate values in view of such a purpose be employed as the predetermined speed and the predetermined time period. From such a viewpoint, in the present embodiment, the same values employed in step S33 of FIG. 12 are used, i.e., a speed sufficient to determine that the finger 31 has not yet stopped is employed as the predetermined speed, and “20 msec” is employed as the predetermined time period.

In a case in which the nail area 31a is moving within the range of the captured image and has not yet stopped, or, even if the nail area 31a is stopped, in a case in which the moving speed thereof immediately before stopping is less than the predetermined speed or the moving time period thereof immediately before stopping is less than the predetermined time period, it is determined that the user has no intention yet to fix (press) the target key area to be pressed, a determination of NO is made in step S42, and control goes back to step S42. That is, until the nail area 31a stops after moving at a speed equal to or more than the predetermined speed for a time period equal to or more than the predetermined time period, the determination process of step S42 is repeated. After that, when it is determined that the nail area 31a has stopped after moving at a speed equal to or more than the predetermined speed for a time period equal to or more than the predetermined time period, it is determined that the user intends to fix the stop position as the target key area (to press the target key area). In such a case, a determination of YES is made in step S42, and control proceeds to step S43.

In step S43, based on the sound data (data in the frequency domain after processing by FFT) acquired from the sound input unit 13, the touch operation detection unit 51 determines whether or not the sound levels of the 20 Hz band and 50 Hz band are equal to or more than −10 dB.

Here, the reason why the process of step S43 is executed after YES is determined in step S42 will be explained. The determination of YES in step S42 is only a determination that the user intends to fix (press) the target key area. The determination process of the previous step S42 is only based on image recognition processing executed on the captured image data. However, such image recognition processing is not sufficient to detect contact of the finger 31 with the top surface of the desk 21 or the like. Therefore, what can be determined in the process of the previous step S42 is no more than that the user intends to fix the target key area. This means that the determination of the previous step S42 is not sufficient to determine whether or not the user has actually performed a press operation by his or her finger 31. For example, there can be a case in which the user has temporarily stopped the finger 31 at a position but, without tapping (without performing a press operation at) the position with the finger 31, moves the finger 31 again. In such a case, if it is determined that the user has performed a press operation at the key area corresponding to the position as the target key area based on the determination in previous step S42 alone, a false determination would be caused. For the purpose of avoiding such a false determination, i.e., for the purpose of determining more reliably (accurately) that the user has performed a press operation at the target key area, the process of step S43 is provided.

More specifically, the 20 Hz band is a frequency band of a sound generated from the desk 21 at the time of tapping (press operation) on the surface thereof with the finger 31. Therefore, the touch operation detection unit 51 can detect the tapping (press operation) of the user on the desk 21 with the finger 31 when the sound level of the 20 Hz band is equal to or more than −10 dB. Furthermore, in the present embodiment, to avoid false detection, it is further determined that the sound level of the 50 Hz band is equal to or more than −10 dB. The 50 Hz band is a frequency band of a sound generally generated from the desk 21 when the surface of the desk 21 vibrates. Therefore, the touch operation detection unit 51 can detect more reliably that the user has tapped (has performed press operation on) the surface of the desk 21 by determining that the sound level of the 20 Hz band is equal to or more than −10 dB and the sound level of the 50 Hz band level is equal to or more than −10 dB. It should be noted that the values such as 20 Hz, 50 Hz, and −10 dB that are employed in the determination process of step S43 are only examples based on the premise that the virtual input device area 41 is formed on the desk 21. This means that, according to properties such as material and size of the surface of the real object on which the virtual input device area 41 is formed, the preferable values to be employed in the determination process of step S43 vary.

In the present embodiment, if the sound level of either one of the 20 Hz band and 50 Hz band is lower than −10 dB, it cannot be determined that the user has performed a press operation by the finger 31, a determination of NO is made in step S43, control goes back to step S42, and the processes thereafter are repeated. This means that, until the nail area 31a stops after moving at a speed equal to or more than the predetermined speed for a time period equal to or more than the predetermined time period and, further, the sound levels of both the 20 Hz band and the 50 Hz band become equal to or more than −10 dB, it is not determined that the user has performed press operation by the finger 31, a determination of NO is made in the processes of steps S42 and/or S43, and the ON detection processing enters a waiting state. After that, when the nail area 31a stops after moving at a speed equal to or more than the predetermined speed for a time period equal to or more than the predetermined time period and, further, the sound levels of both the 20 Hz band and the 50 Hz band become equal to or more than −10 dB, it is finally determined that the user has stopped the finger 31 at the position of the target key area and performed press operation at the position. In such a case, a determination of YES is made in the both processes of steps S42 and S43, and control proceeds to step S44.

In step S44, the touch operation detection unit 51 recognizes the key area where the stopped nail area 31a is located within the captured image as the target key area. In the process of determining YES in step S42, only an action that the user has stopped the finger 31 can be determined. This means that, at the time when YES is determined in step S42, what the touch operation detection unit 51 can recognize is only that the user has an intention to perform a press operation at the stop position of the finger 31. Therefore, at the time when YES is determined in step S42, the stop position of the finger 31 is not yet associated with the position of the virtual input device area 41. For this reason, such processing is executed as in the process of step S44, that the stop position of the finger 31 is associated with the position of the virtual input device area 41 and thereby the target key area is identified.

In step S45, the touch operation detection unit 51 detects a press operation on the target key area. That is, after the target key area is identified in the process of step S44, processing of detecting a press operation on the target key area is executed as the process of step S45.

With this, the ON detection processing ends. This means that, the process of step S14 of FIG. 11 ends, and control proceeds to the input processing of step S15, which is already described above.

As is described above, the information processing apparatus 1 according to the present embodiment is provided with an image capturing unit 12, a sound input unit 13, a touch operation detection unit 51, and input processing unit 53. The image capturing unit 12 captures an image of a finger 31 of a user performing a press operation on a predetermined area such as a top surface of a desk 21, where a virtual input device area 41 associated with a predetermined input device is formed, and outputs data of the captured image. The sound input unit 13 inputs a sound generated at a time of a press operation by the user's finger 31 on the virtual input device area 41 and outputs data of the sound. The touch operation detection unit 51 detects the press operation on the virtual input device area 41 with the user's finger 31 based on the data of the captured image outputted from the image capturing unit 12 and the data of the sound outputted from the sound input unit 13. The input processing unit 53 inputs predetermined information based on the detection result of the touch operation detection unit 51. With this, the information processing apparatus 1 can accept a press operation as one user operations of inputting information by way of the user's hand action without using any input device and can input predetermined information based on the press operation. Thus, the press operation is detected using not only the captured image but also the sound generated at the time of the press operation by the user's finger 31 on the virtual input device area 41. With this, it becomes possible to reliably detect a press operation without any false detection. The captured image data and the sound data used to detect press operation are acquired from the image capturing unit 12 and the sound input unit 13. According to recent progress in technology, a digital camera which constitutes the image capturing unit 12, a microphone which constitutes the sound input unit 13, and the like, can be made at low cost and in a very small size, and can be easily embedded in the information processing apparatus 1 as shown in FIG. 1. Therefore, the information processing apparatus 1 can be implemented in a simple configuration. From a user's point of view, the user can input desired information in the information processing apparatus 1 by simply using the top surface of the desk 21 to simulate a desired input device and performing exactly the same operation as with an input device. Utterances that have been required in Japanese Patent Application Publication No. 1993-19957 is not required for the user. Therefore, the user can input desired information at a desired location (even if at a location where speaking is prohibited) with easier operation. In summary of above, the information processing apparatus 1 can reliably detect a press operation without any false detection with a simple configuration and can provide an easier user operation such as a press operation of pressing the top surface of the desk 21 or the like.

It should be noted that the present invention is not limited to the embodiment described above, and any modifications and improvements thereto within a scope in which an object of the present invention can be realized, are included in the present invention.

For example, in the embodiment described above, as the input device associated with the virtual input device area 41, a computer keyboard and a piano keyboard have been described. However, the present invention is not limited to this. More specifically, for example, a mouse, or more precisely, a moving area of a mouse can be associated with the virtual input device area 41.

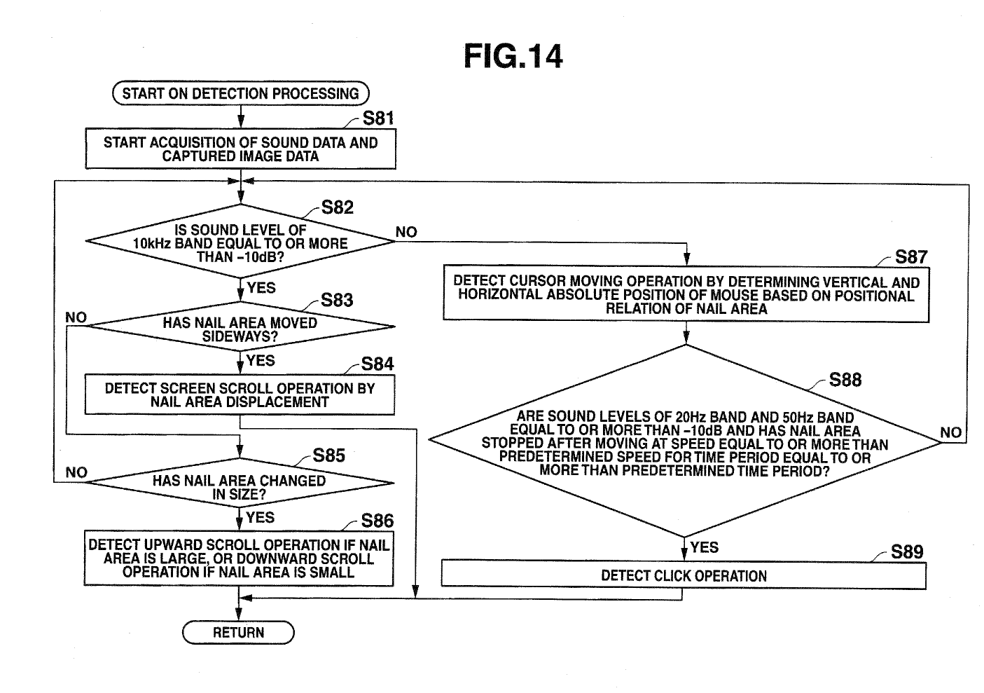

FIG. 14 is a flowchart showing a detailed flow of the ON detection processing in a case in which a mouse is associated with the virtual input device area 41. In the example of FIG. 14, the touch operation detection unit 51 detects a scroll operation, a moving operation of a cursor, a click operation for selecting a target (such as an icon) indicated by the cursor, and the like from among operations a user can perform using a mouse in a screen of the display unit 11. The information processing unit 1 can carry out the ON detection processing of the example of FIG. 14 with exactly the same functional configuration shown in FIG. 4.

As described above, what is associated with the virtual input device area 41 is not a mouse per se, but, more precisely, a moving range of a mouse on a surface of a real object such as the top surface of the desk 21, i.e., the range corresponding to the screen (not shown) of the display unit 11 in the example of FIG. 14. In this case, in the positioning processing, in the process corresponding to step S31 of FIG. 12, a screen (not shown) including a text message such as “Tap your finger and nail strongly where to be the reference position. The center of the screen will be set there.” is displayed. After that, processes corresponding to steps S32 to S35 are executed. That is, the virtual input device area 41 is defined by setting the position of the stopped nail area 31a in the captured image as the reference position (the center of the screen). With this, the positioning processing ends. That is, the process of step S13 of FIG. 11 ends, and control proceeds to the ON detection processing of step S14. Here, the processes of steps S81 and thereafter of FIG. 14 are executed.

In step S81, the touch operation detection unit 51 starts acquisition of data of a sound from the sound input unit 13 and data of a captured image from the image capturing unit 12.

In step S82, based on the sound data (data in the frequency domain after processed by FFT) acquired from the sound input unit 13, the touch operation detection unit 51 determines whether or not the sound level of the 10 kHz band is equal to or more than −10 dB.

More specifically, the 10 kHz band is a frequency band of a sound generated at the time of scratching the top surface of the desk 21 with the nail of the finger 31. Therefore, the touch operation detection unit 51 can detect the scratching of the user on the top surface of the desk 21 with the nail of the finger 31 when the sound level of the 10 kHz band is equal to or more than −10 dB. It should be noted that the values such as 10 kHz and −10 dB that are employed in the determination process of step S82 are only examples based on the premise that the virtual input device area 41 is formed on the desk 21. This means that, according to properties such as material and size of the surface of the real object on which the virtual input device area 41 is formed, the preferable values to be employed in the determination process of step S82 vary.

That the user scratched the top of the desk 21 with the nail of the finger 31 can be conceived as a kind of press operation of pressing a nail and moving the nail being pressed. In view of this, the touch operation detection unit 51 can detect a press operation such as the scratching with a nail as well as a general press operation such as pressing a key area. However, such a kind of press operation detected by the touch operation detection unit 51 as described above is referred to as a “touch operation” in order to clearly distinguish from a general press operation such as pressing a key area. Thus, the touch operation detection unit 51 can detect not only the press operation in a general sense but also various kinds of touch operation. As one example of a touch operation, in the process of step S82 it can be determined whether or not an operation of scratching with a nail could have been performed. Here, it is assumed that a scroll operation is associated with the operation of scratching with a nail. In this case, when YES is determined in step S82, it is determined that a scroll operation could have been performed, and control proceeds to step S83. On the other hand, when NO is determined in step S82, it is determined that a scroll operation could not have been performed, but another kind of operation could have been performed, and control proceeds to step S87.

First, a description will be given of processing after YES is determined in step S82, i.e., processes of steps S83 to S86 executed under the assumption that a scroll operation could have been performed.

Since the touch operation detection unit 51 has recognized the possibility of an operation of scratching with a nail, i.e., scroll operation, based on the sound data acquired from the sound input unit 13, in the processes of steps S83 and after, the captured image data acquired from the image capturing unit 12 is used to detect the scroll operation. The captured image data used here is assumed to be data of images (moving image) time-wise sequentially acquired at the time when or before and after the sound level of the 10 kHz band has become equal to or more than −10 dB.

In step S83, based on the captured image data acquired from the image capturing unit 12, the touch operation detection unit 51 determines whether or not the nail area 31a has moved sideways within the range of the captured image.

If it is determined that the nail area 31a has moved sideways within the range of the captured image, a determination of YES is made in step S83, and control proceeds to step S84. In step S84, the touch operation detection unit 51 detects an operation of scrolling the screen sideways by the displacement of the nail area 31a. With this, the ON detection processing ends. That is, the process of step S14 of FIG. 11 ends, and then the processes of steps S15 to S17 are executed. As a result, the screen displayed on the display unit 11 is horizontally scrolled by the amount of the user's sideways scratch with the nail.

On the other hand, if it is determined that the nail area 31a has not moved sideways within the range of the captured image, i.e., if NO is determined in step S83, control proceeds to step S85. In step S84, based on the captured image data acquired from the image capturing unit 12, the touch operation detection unit 51 determines whether or not the nail area 31a has changed in size (occupancy in the captured image) within the range of the captured image.

If it is determined that the nail area 31a has not changed in size, i.e., if NO is determined in step S85, it is determined that no scroll operation has been performed, control goes back to step S82, and the processes thereafter are repeated.

On the other hand, if it is determined that the nail area 31a has changed in size, i.e., if YES is determined in step S85, control proceeds to step S86. In step S86, the touch operation detection unit 51 detects an operation of scrolling upwards if a change of the nail area 31a is large and detects an operation of scrolling downwards if a change of the nail area 31a is small. With this, the ON detection processing ends. That is, the process of step S14 of FIG. 11 ends, and then the processes of steps S15 to S17 are executed. As a result, the screen displayed on the display unit 11 is vertically scrolled by the amount of the user's upward or downward scratch with the nail.

In the above, a description has been given of the ON detection processing in a case in which the user performed scroll operation by scratching with a nail. Next, a description will be given of the ON detection processing in a case in which the user has performed a cursor moving operation and click operation. Here, it is assumed that the user is holding a virtual mouse in the right hand, and clicks the virtual mouse by tapping (press operation in a general sense) the top surface of the desk 21 or the like with a predetermined finger 31 such as the index finger or the like of the right hand. It is assumed that an operation of moving the finger 31 within the range of the virtual input device area 41 is associated with the cursor moving operation, and that an operation of tapping (press operation in a general sense) the top surface of the desk 21 or the like with the finger 31 is associated with the click operation. In this case, after NO is determined in step S82, control proceeds to step S87.

In step S87, the touch operation detection unit 51 computes a positional relationship of the nail area 31a from the captured image data acquired from the image capturing unit 12, determines the vertical and horizontal absolute position of the virtual mouse based on the positional relation of the nail area 31a in relation to the captured image, and thereby detects a cursor moving operation. Incidentally, it is assumed that equivalent processes to the input processing of step S15 of FIG. 11 and the display processing of step S16 are sequentially executed during the process of step S87, and that the cursor in the screen of the display unit 11 sequentially moves in accordance with the locus of the user's finger 31.

In step S88, based on the sound data (data in the frequency domain after processing by FFT) acquired from the sound input unit 13, the touch operation detection unit 51 determines whether or not the sound levels of the 20 Hz band and 50 Hz band are equal to or more than −10 dB and, further, the nail area 31a has stopped after moving at a speed equal to or more than a predetermined speed for a time period equal to or more than a predetermined time period. This means that the process of step S88 is a process equivalent to unified selection processing of steps S42 and S43 of FIG. 13. Also, the process is the same as the selection processing of steps S42 and S43 of FIG. 13 in that the purpose thereof is to determine whether or not the user has stopped his or her the finger 31 at a predetermined position in the virtual input device area 41 formed on the top surface of the desk 21 or the like and has performed a tapping operation (press operation in a general sense) with the finger 31 at the predetermined position. However, the example of FIG. 14 is different from the example of FIG. 13 in that the stop position of the finger 31 corresponds to the stop position of the cursor such as a position indicating a symbol (an icon or the like) to be selected, and the tap operation (press operation in a general sense) with the finger 31 at the predetermined position corresponds to the click operation. Therefore, the predetermined speed and the predetermined time period employed in step S88 of FIG. 14 are not limited, and any values can be employed. However, it is preferable to employ the same values as employed in step S42 of FIG. 13. That is, it is preferable that a speed sufficient to determine that the finger 31 has not yet stopped is employed as the predetermined speed and “20 msec” is employed as the predetermined time period.

Thus, the determination process of step S88 is, in summary, processing of determining whether or not a click operation has been performed. Therefore, when NO is determined in step S88, it is determined that a click operation has not been performed, control goes back to step S82, and processes thereafter are repeated. On the other hand, when YES is determined in step S88, control proceeds to step S89. In step S89, the touch operation detection unit 51 detects a click operation. With this, the ON detection processing ends. That is, the process of step S14 of FIG. 11 ends, and processes of steps S15 to S17 are then executed. As a result, exactly the same processing as when a mouse is clicked is executed, and the mouse click sound or the like is outputted as appropriate.

In the above, a description has been given of one variation of the present invention in which a mouse is associated with the virtual input device area 41.

In addition, in the embodiment described above, the surface where the virtual input device area 41 is formed has been described as a top surface of the desk 21. However, the present invention is not limited to this, and any surface including an uneven one as well as an even one can suffice as long as the surface is touchable by the user's finger 31.

Furthermore, in the embodiment described above, sound data has been used for detection of various operations such as scratching with the nail of the finger 31 as well as a touch operation of the finger 31 with the virtual input device area 41, i.e., a press operation in a general sense realized by tapping the finger 31. However, the present invention is not limited to this. That is, any kind of data can be employed for detecting this type of touch operation as long as the data can indicate a state of the real object or the real world that changes due to contact of the finger 31 or the nail thereof with the virtual input device area 41 (a surface such as the top surface of the desk 21). For example, a touch operation can be detected based on state data that indicates a state of vibration of a surface generated due to contact of the finger 31 with the surface. In such a case, what is called a vibration sensor is provided to the information processing apparatus 1 along with or in place of the sound input unit 13, and the detection result of the vibration sensor is provided to the touch operation detection unit 51 as one kind of state data. From such a viewpoint, the sound data used in the embodiment described above is only an example of state data, since sound data is indicative of an state of vibration of air changing due to contact of the finger 31 or the nail thereof with the virtual input device area 41, i.e., data that indicates level and pitch (frequency) of sound. Furthermore, in order to detect the touch operation, it suffices if there are provided data of a captured image of the surface where the virtual input device area 41 is formed and identification information that can identify a state of contact as to whether or not the user's finger 31 or the nail thereof has touched the virtual input device area 41. That is, state data such as sound data and detection results of the vibration sensor is only an example of identification information. Here, “state of contact” includes not only various states of contact but also a state of no contact. Therefore, it becomes possible to determine whether or not contact has occurred according to the information indicating the “state of contact”.

Furthermore, for example, in the embodiment described above, the information processing apparatus according to the present invention is configured by a digital photo frame equipped with a digital camera. However, the present invention is not limited to this and can be applied to any electronic device that has an image capturing function and state data input function (preferably, sound input function). For example, the present invention can be applied to a personal computer, a portable navigation device, a portable game device, and the like.

The series of processes described above can be executed by hardware and also can be executed by software.

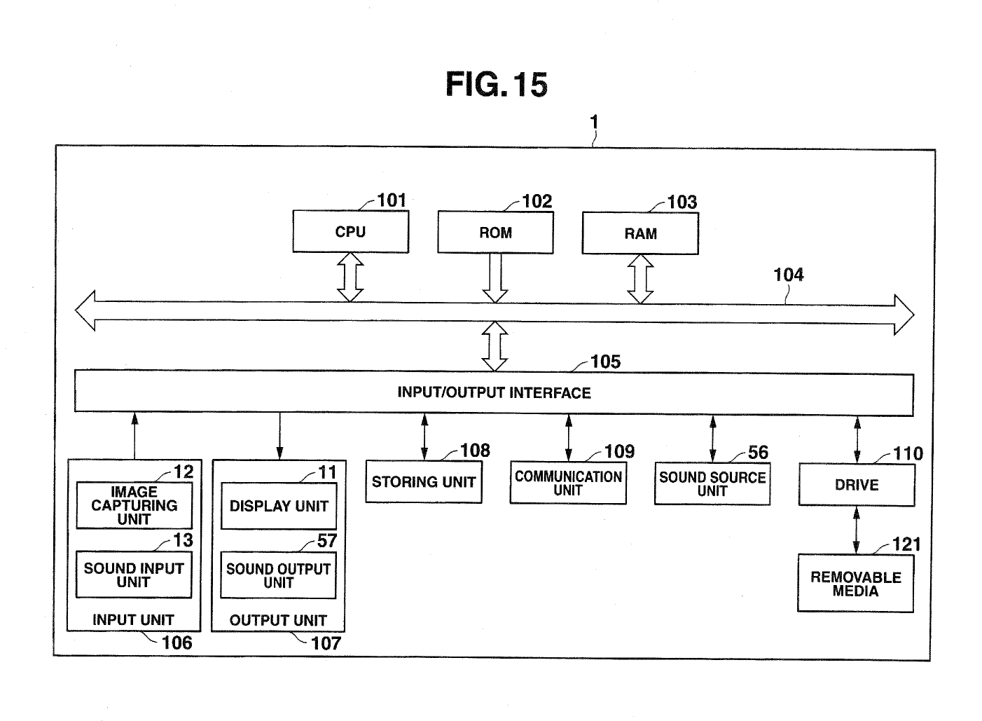

FIG. 15 is a block diagram showing a hardware configuration of the information processing apparatus 1 in a case in which the series of processes described above are to be executed by software.

The information processing apparatus 1 is provided with a CPU (Central Processing Unit) 101, a ROM (Read Only Memory) 102, a RAM (Random Access Memory) 103, a bus 104, an input/output interface 105, an input unit 106, an output unit 107, a storing unit 108, a communication unit 109, a drive 110, and the abovementioned sound source unit 56.

The CPU 101 executes various processes according to programs that are stored in the ROM 102. Alternatively, the CPU 101 executes various processes according to programs that are loaded from the storing unit 108 to the RAM 103. The RAM 103 also stores data and the like, necessary for the CPU 101 to execute the various processes, as appropriate.

For example, from among the functional constituent elements of FIG. 4 described above, the touch operation detection unit 51, the input processing unit 53, the display control unit 54, and the sound control unit 55 can be configured as a combination of the CPU 101 as hardware and the program stored in the ROM 102 and the like as software.

The CPU 101, the ROM 102, and the RAM 103 are connected to one another via the bus 104. The bus 104 is also connected with the input/output interface 105. Besides the sound source unit 56 described above, the input unit 106, the output unit 107, the storing unit 108, the communication unit 109, and the drive 110 are connected with the input/output interface 105.

The input unit 106 is configured by an operation unit (not shown) and the like as well as the image capturing unit 12 and the sound input unit 13 shown in FIG. 4, for example, and includes the vibration sensor as needed. The output unit 107 is configured by the display unit 11 and the sound output unit 57 shown in FIG. 4 and the like, for example. The storing unit 108 is configured by a hard disk and the like and stores various kinds of data. For example, the specification information storing unit 52 is configured as a region within the storing unit 108 and stores the specification information described above. The communication unit 109 controls communication with other devices via the Internet or the like.

To the drive 110, removable media 121 such as a magnetic disk, an optical disk, a magneto-optical disk, or a semiconductor memory may be mounted as appropriate. Programs read by the drive 110 are installed in the storing unit 108 or the like as needed.

In a case in which the series of processing is to be executed by software, the program configuring the software is installed from a network or a storage medium in a computer or the like. The computer may be a computer incorporated in dedicated hardware. Alternatively, the computer may be a computer capable of executing various functions by installing various programs, i.e., a general-purpose personal computer, for example.

The storage medium containing the program can be configured not only by the removable media 121 distributed separately from the device main body for supplying the program to a user, but also by a storage medium or the like supplied to the user in a state incorporated in the device main body in advance. The removable media is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), and the like. The magnetic optical disk is composed of an MD (Mini-Disk) or the like. The storage medium supplied to the user in a state of being incorporated in the device main body in advance includes the ROM 102 storing the program, a hard disk included in the storing unit 108, and the like, for example.

It should be noted that, in the present description, the step describing the program stored in the storage medium includes not only the processing executed in a time series following this order, but also includes processing executed in parallel or individually, which is not necessarily executed in a time series.

What is claimed is:

1. An information processing apparatus that regards a predetermined surface as a virtual input device area, and inputs predetermined information when a user performs a touch operation of causing a finger to touch the virtual input device area, the information processing apparatus, comprising:
an image capturing unit that captures an image of the surface where the virtual input device area is formed and outputs data of the captured image;
an identification information detection unit that detects identification information indicative of a state of contact of the finger of the user with the virtual input device area;
a touch operation detection unit that detects the touch operation on a predetermined area of the virtual input device area, based on the data of the captured image outputted from the image capturing unit, and the identification information detected by the identification information detection unit; and
an information input unit that inputs the predetermined information based on a detection result of the touch operation detection unit.

2. An information processing apparatus as set forth in claim 1, further comprising:
a specification information storing unit that stores specification information specifying a position of the virtual input device area in the captured image, wherein
the touch operation detection unit detects the predetermined area that is a target of the touch operation based on a relative position of a finger of the user in the captured image, and the specification information stored in the specification information storing unit, and
detects that the touch operation is performed on the predetermined area by detecting contact of the finger of the user with the surface based on the identification information detected by the identification information detection unit when, or before or after, the captured image is captured.

3. An information processing apparatus as set forth in claim 1, wherein
the identification information detection unit includes a unit that inputs sound generated as a result of contact of the finger of the user with the virtual input device area, and detects data of the sound as the identification information.

4. An information processing apparatus as set forth in claim 3, wherein
the touch operation detection unit detects contact of the finger of the user with the surface by detecting that a sound level of at least one frequency band is greater than or equal to a threshold, based on data of the sound detected as the identification information by the identification information detection unit.

5. An information processing apparatus as set forth in claim 2, wherein
the touch operation detection unit detects a position where the finger has stopped as the predetermined area, by detecting that the finger has stopped after moving at a speed equal to or more than a predetermined speed for a time period equal to or more than a predetermined time period, based on the data of the captured image that is continuous in time.

6. An information processing method of an information processing apparatus that regards a predetermined surface as a virtual input device area, and inputs predetermined information when a user performs a touch operation of causing a finger to touch the virtual input device area,
the information processing apparatus being provided with an image capturing unit that captures an image of the surface where the virtual input device area is formed and outputs data of the captured image, the information processing method comprising the steps of:
an identification information detection step of detecting identification information capable of identifying whether or not the finger of the user has touched the virtual input device area;
a touch operation detection step of detecting the touch operation on a predetermined area of the virtual input device area, based on the data of the captured image outputted by the image capturing unit, and the identification information detected in the identification information detection step; and
an information input step of inputting the predetermined information based on a detection result of the touch operation detection step.

7. A storage medium readable by a computer used in an information processing that regards a predetermined surface as a virtual input device area, and inputs predetermined information when a user performs a touch operation of causing a finger to touch the virtual input device area, and that has an image capturing unit that captures an image of the surface where the virtual input device area is formed and outputs data of the captured image, the storage medium having stored therein a program executable by the computer to function as:
an identification information detection unit that detects identification information indicative of a state of contact of the finger of the user with the virtual input device area;
a touch operation detection unit that detects the touch operation on a predetermined area of the virtual input device area, based on the data of the captured image outputted from the image capturing unit, and the identification information detected by the identification information detection unit; and
an information input unit that inputs the predetermined information based on a detection result of the touch operation detection unit.
